(19) United States
(12) Patent Application Publication
(10) Pub. No.: US 2011/0315671 A1
(43) Pub. Date: Dec. 29, 2011

(54) FORMING METHODS OF A TOILET SEAT WHICH IS INTEGRALLY FORMED WITH AN EMBEDDED HEATING WIRE AND PRODUCTS THEREOF

(76) Inventors: I-Shou TSAI, Longjing Township (TW); Lin-Ho Liu, Zhuqi Township (TW)

(21) Appl. No.: 12/823,639

(22) Filed: Jun. 25, 2010

(51) Int. Cl. H05B 1/00; B29C 51/10

(52) U.S. Cl. 219/217; 264/272.11

(57) ABSTRACT

A forming method of a toilet seat which is integrally formed with an embedded heating wire uses primarily a plastic material or glass fiber reinforced plastic to embed a heating wire in a toilet seat, forming the toilet seat which is integrally formed with the embedded heating wire. The toilet seat which is integrally formed with the embedded heating wire is characterized in that the said toilet seat is embedded with the heating wire which contacts with the toilet seat without leaving a gap, thereby forming the integrally formed toilet seat.

### BACKGROUND OF THE INVENTION

a) Field of the Invention

The present invention relates to a toilet seat heating device and more particularly to forming methods of a toilet seat which is integrally formed with a heating wire and products thereof.

b) Description of the Prior Art

A toilet used now is primarily constituted by a bowl and a water tank. As being primarily a ceramic product, the bowl will provide an ice cold feeling. Therefore, an upper side of the bowl will be usually added with a plastic toilet seat to overcome the ice cold problem. However, when air temperature drops, the plastic toilet seat is still rather cold. Thus, there are vendors who use water heating pipes to allow temperature of the toilet seat to close to that of a human body, so that people can be more comfortable when using the toilet. FIG. 1 shows a cutaway view of a conventional toilet seat A that includes primarily a plastic cover B and a plastic seat C which are up-down symmetric, whereas a bottom surface of the plastic cover B is formed with plural lower grooves B1 and a top surface of the plastic seat C is formed with plural upper grooves C1, such that plural heating pipes D can be accommodated between each lower groove B1 and upper groove C1. Then, the plastic cover B and the plastic seat C are attached together, and when water in each heating pipe D is heated up to produce heat, the heat can be conducted upward through the plastic cover B, so as to achieve a heating effect. Nevertheless, when the heating pipes D are heated up, as the plastic cover B is provided with a considerable thickness, the heat conduction efficiency is not very perfect, which will consume electricity excessively.

### SUMMARY OF THE INVENTION

The primary object of the present invention is to provide forming methods of a toilet seat which is integrally formed with an embedded heating wire, wherein the heating wire is embedded in the toilet seat using primarily a plastic material or glass fiber reinforced plastic, thereby forming the toilet seat which is integrally formed with the embedded heating wire.

An aforementioned forming method using the plastic material to embed the heating wire includes following steps:
(a) providing a mold having a mold cavity and filling the mold cavity with a plastic material;
(b) embedding a heating wire in the plastic material which is inside the mold cavity;
(c) heating and pressurizing the mold, enabling the plastic material to be combined with an exterior surface of the heating wire after the plastic material has been molten by heat; and
(d) releasing the mold after the plastic material has been hardened, so as to form a toilet seat which is integrally formed with the embedded heating wire.

An aforementioned forming method using the plastic material to embed the heating wire includes following steps:
(a) providing a mold having a mold cavity and putting a bottom layer, which is provided with an annular groove, into the mold cavity;
(b) embedding the heating wire in the groove of the bottom layer and filling the mold cavity with a plastic material on the bottom layer;
(c) heating and pressurizing the mold, enabling the bottom layer, which is provided with the heating wire, to be combined with the plastic material and hardened; and
(d) releasing the mold after hardening to form the toilet seat which is integrally formed with the embedded heating wire.

In the aforementioned forming method, the said bottom layer can be plate-shaped plastic or plate-shaped wood.

An aforementioned forming method using the glass fiber reinforced plastic to embed the heating wire includes following steps:
(a) providing a glass fiber which is pre-impregnated with resin, forming a pre-preg;
(b) providing a mold having a mold cavity and putting plural layers of the pre-preg into the mold cavity, making a first stack;
(c) putting the heating wire on the first stack;
(d) making a second stack on the first stack which is placed with the heating wire, enabling the heating wire to be embedded between the first stack and the second stack;
(e) heating and pressurizing the mold, enabling the first stack to be combined with the second stack and hardened; and
(f) releasing the mold after hardening to form the toilet seat which is integrally formed with the embedded heating wire.

The aforementioned forming methods using the plastic material to embed the heating wire can utilize one of the forming methods including compressing, extrusion, transferring and casting; whereas, the forming method using the glass fiber reinforced plastic to embed the heating wire can use stack compressing.

The present invention provides a toilet seat which is integrally formed with an embedded heating wire, with the said toilet seat being provided between a bowl and a toilet cover. The present invention is characterized in that the said toilet seat includes structures which are constituted by plastic and the heating wire embedded by the plastic, whereas the said heating wire contacts completely with the plastic without leaving a gap, thereby forming the integrally formed toilet seat.

Additionally, the present invention provides a toilet seat which is integrally formed with an embedded heating wire, with the said toilet seat being provided between a bowl and a toilet cover. The present invention is characterized in that the said toilet seat includes structures which are constituted by plastic, plate-shaped plastic and the heating wire embedded by the plastic and plate-shaped plastic.

On the other hand, in the aforementioned toilet seat which is integrally formed with an embedded heating wire, the said heating wire is preferably located at an upper part of the toilet seat and adjacent to a surface of the toilet seat.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cutaway view of a conventional toilet seat.

FIG. 2 shows a constitution diagram of a toilet of the present invention.

FIG. 3 shows a top perspective view of a toilet seat of the present invention.

FIG. 4 shows a cutaway view along a line A-A in FIG. 3.

FIG. 5 shows a three-dimensional view of a heating assembly of the present invention.

FIG. 6 shows a flow diagram of a forming method of a first embodiment of the present invention.

FIG. 7 shows a mold forming diagram of the forming method for the first embodiment of the present invention.

FIG. 8 shows a flow diagram of a forming method of a second embodiment of the present invention.

FIG. 9 shows a mold forming diagram of the forming method for the second embodiment of the present invention.

FIG. 10 shows a flow diagram of a forming method of a third embodiment of the present invention.

FIG. 11 shows a mold forming diagram of the forming method for the third embodiment of the present invention.

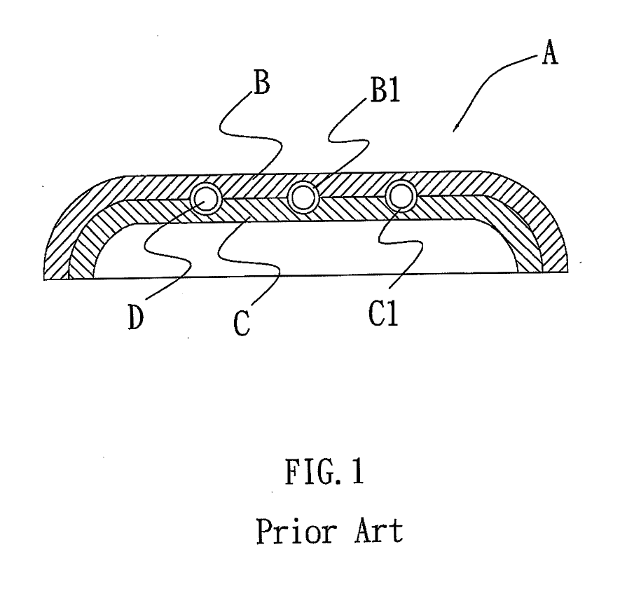

### DETAILED DESCRIPTION OF THE PREFERRED EMBODIMENTS

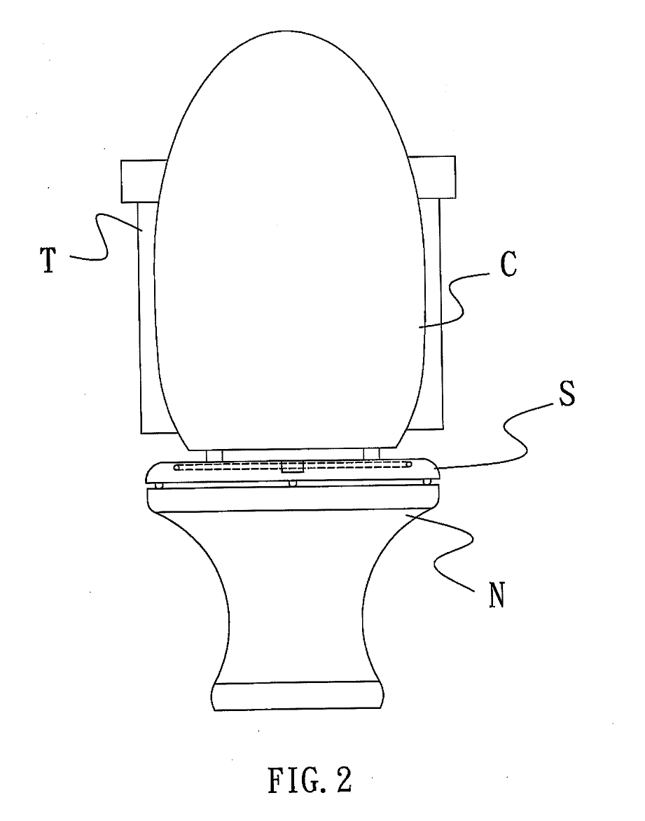

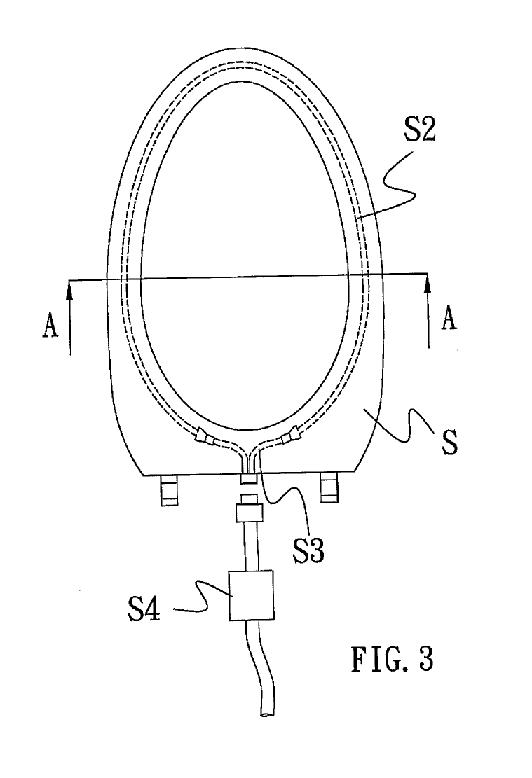

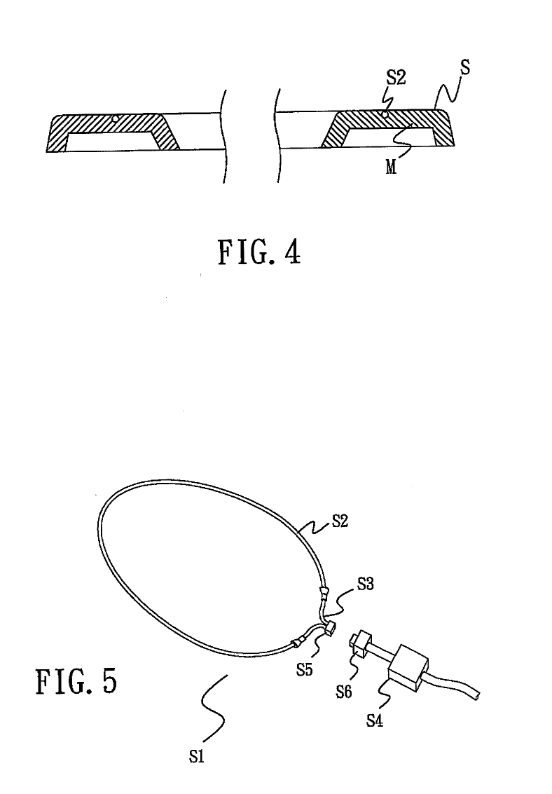

Referring to FIGS. 2 to 5, a toilet comprises primarily a bowl N, a toilet seat S, a toilet cover C and a water tank T. The toilet seat S is provided with a heating assembly S1 which includes a heating wire S2, electric wire terminals S3 and a power controller S4. Two ends of the said heating wire S2 are connected with the electric wire terminals S3 which are provided with a first connector S5, an end of the power controller S4 is connected with a power source and the other end is provided with a second connector S6. The first connector S5 and the second connector S6 are embedded in a water-proofed situation and the second connector S6 can be inserted into the first connector S5 to conduct with the power source. The electric wire terminals S3 and the first connector S5 can be fixed at a tail edge of the toilet seat S or extended outside the toilet seat S.

The toilet which is integrally formed with the embedded heating wire, according to the present invention, is characterized in that the heating wire S2 is embedded in the toilet seat S and contacts with the toilet seat S completely without leaving a gap; whereas, the heating wire S2 is preferably located at an upper part of the toilet seat S. As the heating wire S2 is adjacent to a surface of the toilet seat S, heat can be quickly conducted to the surface to provide a warm toilet seat.

The toilet seat which is integrally formed with the embedded heating wire, according to the present invention, uses primarily a plastic material or glass fiber reinforced plastic to embed the heating wire, thereby forming a toilet seat which is integrally formed with an embedded heating wire.

In the aforementioned forming methods that use the plastic material to embed the heating wire, the said plastic material includes an adhesive agent, a filler and pigment. The said adhesive agent can be thermosetting resin or thermoplastic resin, optionally; the said thermosetting resin can be phenol formaldehyde (PF) resin, urea formaldehyde (UF) resin, epoxy resin, silicone resin, melamine resin, alkyd resin, unsaturated polyester (UP) resin or polyurethane (PU) resin; whereas, the said thermosetting resin can be general-purpose plastic, engineering plastic or blended plastic. For example, the general-purpose plastic can be polyethylene (PE), polypropylene (PP), polystyrene (PS), polyvinyl chloride (PVC), acrylonitrile-butadiene-styrene (ABS) or polymethylmethacrylate (PMMA); the engineering plastic can be polyamide (PA, nylon), polybutylene terephthalate (PBT), polyethylene terephthalate (PET), polymethylpentene (PMP), polycarbonate (PC) resin, polyacetal engineering polymer (POM), modified polyphenylene oxide (MPPO) resin, liquid crystal polymer (LCP), polyamide-imide (PAI), polychlorinated triphenyl (PCT), polyetheretherketone (PEEK), polyether-imide (PEI), polyethersulfone (PES), polyimide (PI), polyphenylene sulfide (PPS) or polysulfone (PFS); whereas, the blended plastic can be ABS/nylon, ABS/PVC, ABS/PC, ABS/SMA (styrene maleic anhydride), PPO (polyphenylene oxide)/PS, PPE (polyphenylene ether)/PS, ABS/polysulfone, PC/PBT, PC/PET, PC/PE, PC/ASA (acrylonitrile-styrene-acrylate), PC/PU, PC/SMA, PBT/ethylene, PET/elastomer, PET/PMMA, PET/polysulfone, PPO/PBT, nylon/ethylene, nylon/elastomer, nylon/PTFE (polytetrafluoroethylene) or PPO/nylon. On the other hand, in the aforementioned forming methods, the said filler is an organic or inorganic material, such as wood flours, cellulose pulp, a mineral material like asbestos or mica; the filler can be a powder or a long fiber, acting as an extender and sometimes also achieving an effect of reinforcement to strengthen the resin. A formula of making the aforementioned plastic can be changed by various proportions, such as using 45% of PF resin, 50% of filler and 5% of pigment. Besides, a toughening agent and a release agent which facilitates releasing the mold during formation, can be added. As being a solid under normal temperature, the resin has to be minced, put on with the pigment, added with the release and toughening agents and finally put on with the filler before completely milling. Next, the resin is let to pass through a circulating heating barrel. The adhesive agent is molten by heat to blend the filler and when exiting the barrel, the resin is in a plate shape and is made into grains after cooling; this final product is a molding powder.

The aforementioned forming methods using the plastic material to embed the heating wire can use one of the forming methods including compressing, extrusion, transferring and casting.

The aforementioned forming method using the glass fiber reinforced plastic to embed the heating wire can use stack compressing to combine an exterior of the heating wire with the glass fiber reinforced plastic for hardening, allowing the heating wire to be embedded in the glass fiber reinforced plastic.

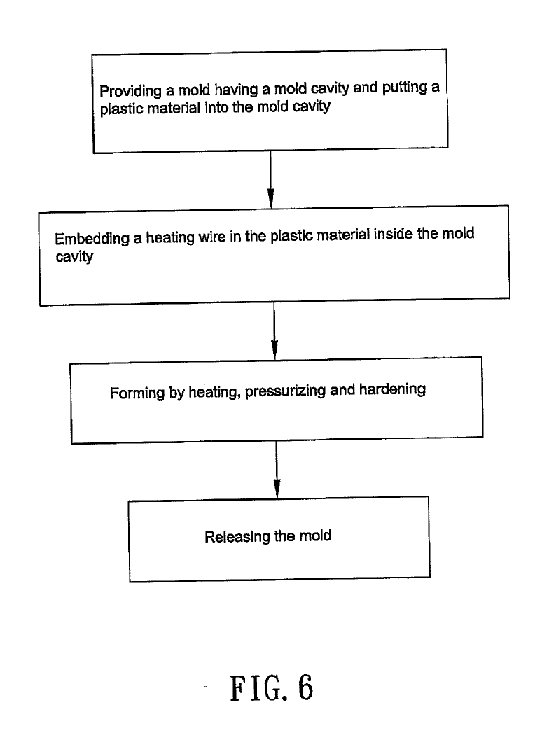

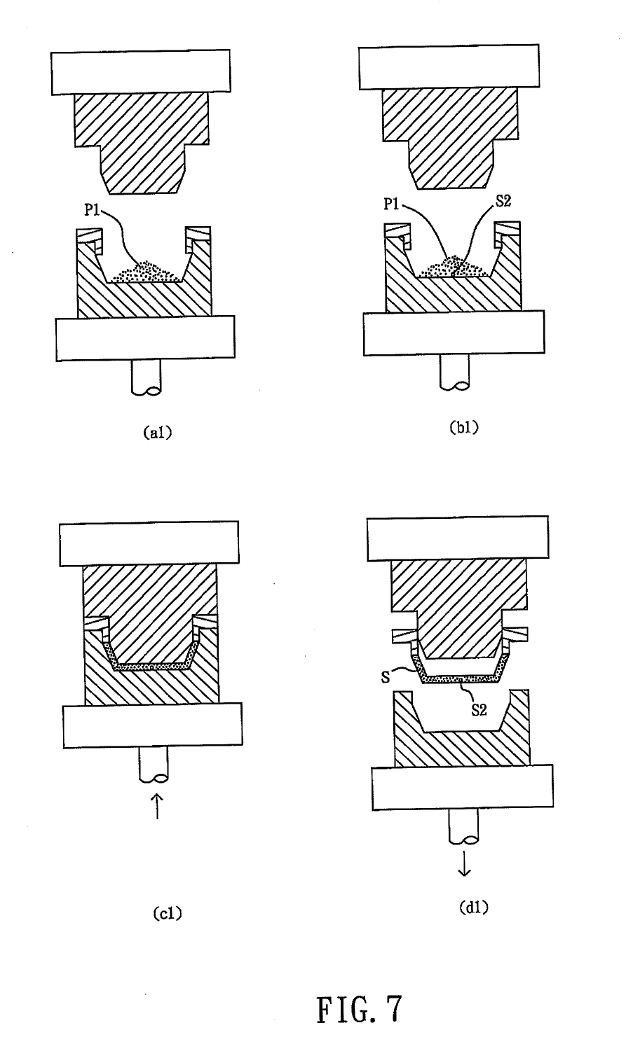

Forming methods 1, 2 of the present invention are described hereinafter using the compressing technology. FIG. 6 shows a flow diagram of the forming method 1 and FIG. 7 shows a mold forming diagram of the forming method 1. The forming method 1 includes following steps:
(a) providing a mold having a mold cavity and filling the mold cavity with a plastic material P1;
(b) embedding the heating wire S2 in the plastic material P1 which is inside the mold cavity;
(c) heating and pressurizing the mold, enabling the plastic material to be combined with an exterior surface of the heating wire after the plastic material has been molten by heat; and
(d) releasing the mold after the plastic material has been hardened, so as to form the toilet seat S which is integrally formed with the embedded heating wire S2.

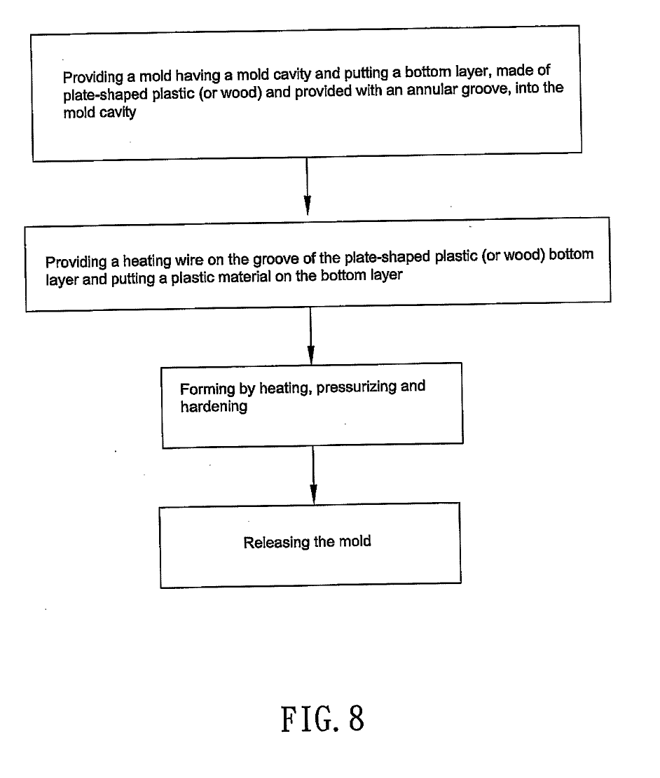

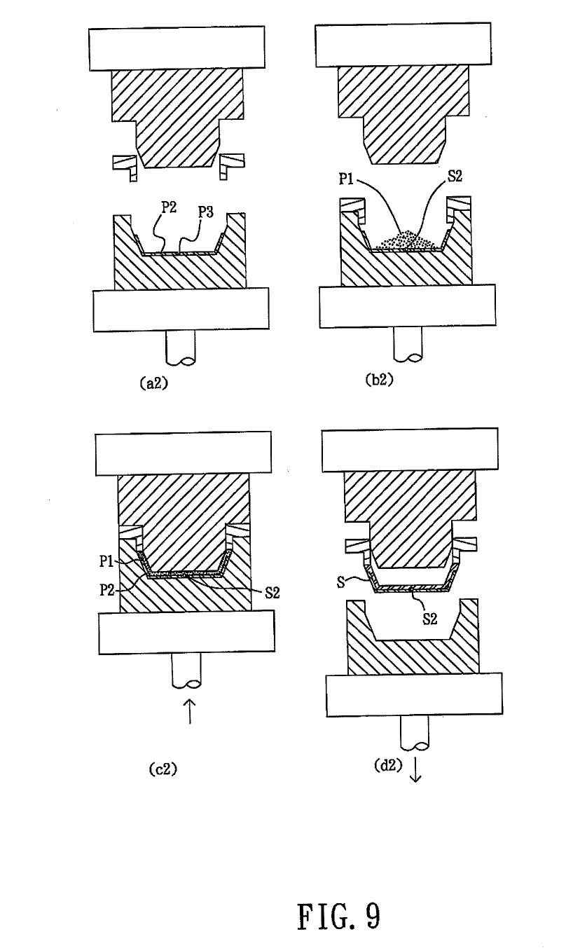

FIG. 8 shows a flow diagram of the forming method 2 and FIG. 9 shows a mold forming diagram of the forming method 2. The forming method 2 includes following steps:
(a) providing a mold having a mold cavity and putting a bottom layer P2 which is made of plate-shaped plastic (or wood) and is provided with an annular groove P3, into the mold cavity;
(b) embedding the heating wire S2 in the groove P3 of the plate-shaped plastic (or wood) bottom layer P2 and filling the mold cavity with plastic material P1 on the bottom layer P2;
(c) heating and pressurizing the mold, enabling the bottom layer P2, which is provided with the heating wire S2, to be combined with the plastic material P1 and hardened; and
(d) releasing the mold after hardening to form the toilet seat S which is integrally formed with the embedded heating wire S2.

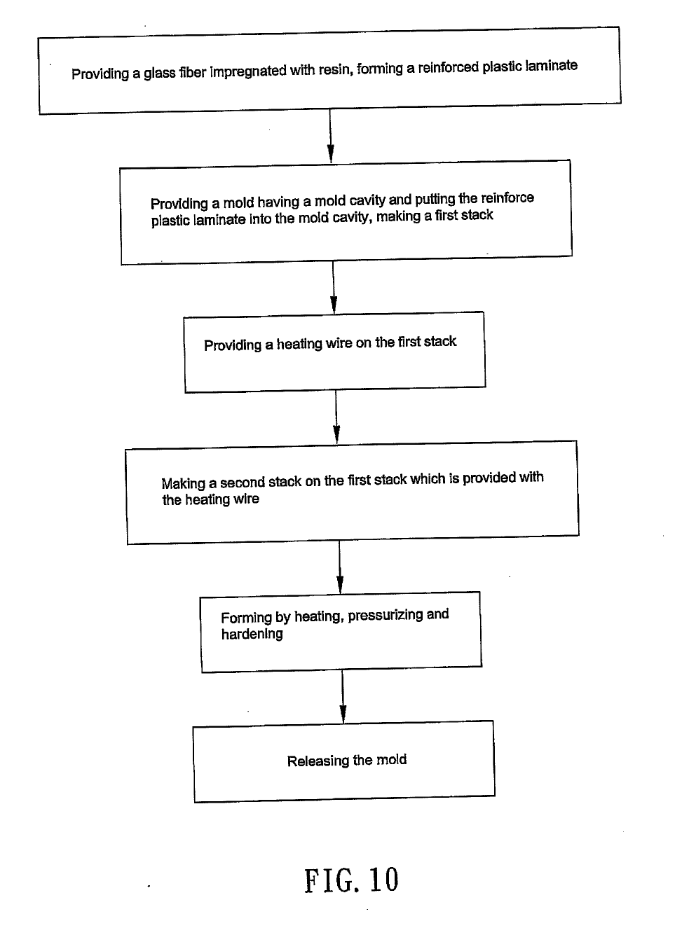

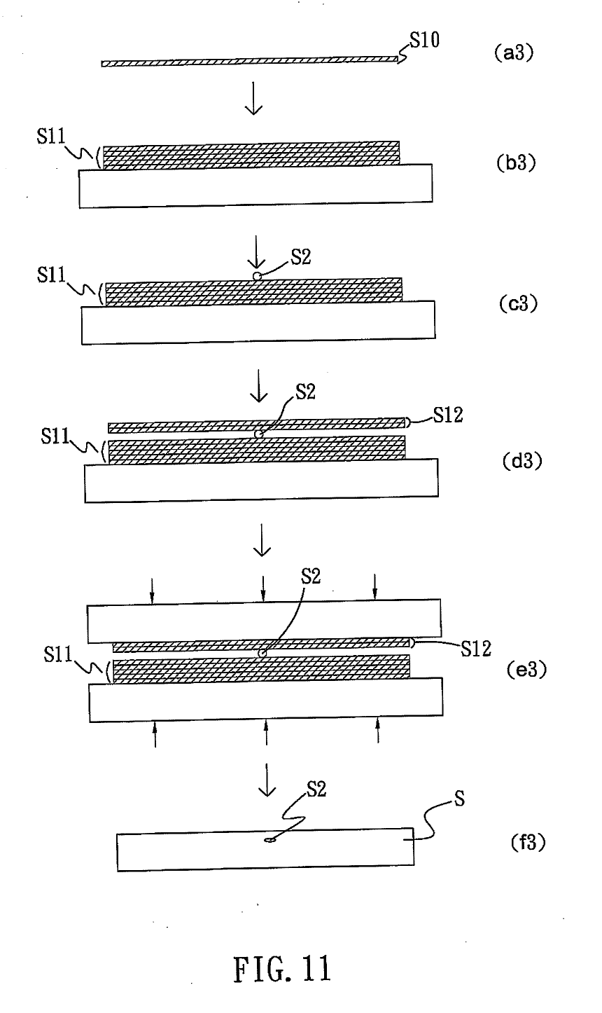

A forming method 3 of the present invention is described hereinafter using the stack compressing technology. FIG. 10 shows a flow diagram of the forming method 3 and FIG. 11 shows a mold forming diagram of the forming method 3. The forming method 3 includes following steps:
(a) providing a glass fiber which is pre-impregnated with resin, forming a pre-preg S10;
(b) providing a mold having a mold cavity and putting plural layers of the pre-preg S10 into the mold cavity, making a first stack S11;
(c) putting the heating wire S2 on the first stack S11;
(d) making a second stack S12 on the first stack S11 which is placed with the heating wire S2, enabling the heating wire S2 to be embedded between the first stack S11 and the second stack S12;
(e) heating and pressurizing the mold, enabling the first stack S11 to be combined with the second stack S12 and hardened; and
(f) releasing the mold after hardening to form the toilet seat S which is integrally formed with the embedded heating wire S2.

In the aforementioned forming method, the said resin is a thermosetting resin which can be PF resin, UF resin, epoxy resin, silicon resin, melamine resin, alkyd resin, UP resin or PU resin.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A forming method of a toilet seat which is integrally formed with an embedded heating wire, using primarily a plastic material or glass fiber reinforced plastic to embed a heating wire, thereby forming a toilet seat which is integrally formed with an embedded heating wire.

2. The forming method of a toilet seat which is integrally formed with an embedded heating wire, according to claim 1, wherein the forming method using the plastic material to embed the heating wire includes following steps:
(a) providing a mold having a mold cavity and filling the mold cavity with a plastic material;
(b) embedding a heating wire in the plastic material which is inside the mold cavity;
(c) heating and pressurizing the mold, enabling the plastic material to be molten by heat and then combined with an exterior surface of the heating wire; and
(d) releasing the mold after the plastic material has been hardened, thereby forming a toilet seat which is integrally formed with an embedded heating wire.

3. The forming method of a toilet seat which is integrally formed with an embedded heating wire, according to claim 1, wherein the forming method using the plastic material to embed the heating wire includes following steps:
(a) providing a mold having a mold cavity and putting a bottom layer, which is provided with an annular groove, into the mold cavity;
(b) providing a heating wire on the groove of the bottom layer and putting a plastic material on the bottom layer;
(c) heating and pressurizing the mold, enabling the bottom layer, which is provided with the heating wire, to be combined with the plastic material and hardened; and
(d) releasing the mold after hardening, thereby forming a toilet seat which is integrally formed with an embedded heating wire.

4. The forming method of a toilet seat which is integrally formed with an embedded heating wire, according to claim 3, wherein the bottom layer is plate-shaped plastic or plate-shaped wood.

5. The forming method of a toilet seat which is integrally formed with an embedded heating wire, according to claim 1, wherein the forming method using the glass fiber reinforced plastic to embed the heating wire includes following steps:
(a) providing a glass fiber which is pre-impregnated with resin, forming a pre-preg;
(b) providing a mold having a mold cavity and putting plural layers of pre-preg into the mold cavity, making a first stack;
(c) putting a heating wire on the first stack;
(d) making a second stack on the first stack which is provided with the heating wire, enabling the heating wire to be embedded between the first stack and the second stack;
(e) heating and pressurizing the mold, enabling the first stack to be combined with the second stack and hardened; and
(f) releasing the mold after hardening, thereby forming a toilet seat which is integrally formed with an embedded heating wire.

6. The forming method of a toilet seat which is integrally formed with an embedded heating wire, according to claim 5, wherein the said resin is preferably thermosetting resin.

7. The forming method of a toilet seat which is integrally formed with an embedded heating wire, according to claim 1, wherein the plastic material includes an adhesive agent of 45% of weight, a filler of 55% of weight and pigment of 5% of weight, with proportions of contents thereof being adjusted depending upon intensity required.

8. The forming method of a toilet seat which is integrally formed with an embedded heating wire, according to claim 7, wherein the adhesive agent is thermosetting resin or thermoplastic resin, optionally.

9. The forming method of a toilet seat which is integrally formed with an embedded heating wire, according to claim 8, wherein the thermosetting resin is phenol formaldehyde (PF) resin, urea formaldehyde (UF) resin, epoxy resin, silicone resin, melamine resin, alkyd resin, unsaturated polyester (UP) resin or polyurethane (PU) resin.

10. The forming method of a toilet seat which is integrally formed with an embedded heating wire, according to claim 8, wherein the thermoplastic resin uses general-purpose plastic, engineering plastic or blended plastic, with the general-purpose plastic being polyethylene (PE), polypropylene (PP), polystyrene (PS), polyvinyl chloride (PVC), acrylonitrile-butadiene-styrene (ABS) or polymethylmethacrylate (PMMA), the engineering plastic being polyamide (PA, nylon), polybutylene terephthalate (PBT), polyethylene terephthalate (PET), polymethylpentene (PMP), polycarbonate (PC) resin, polyacetal engineering polymer (POM), modified polyphenylene oxide (MPPO) resin, liquid crystal polymer (LCP), polyamide-imide (PAI), polychlorinated triphenyl (PCT), polyetheretherketone (PEEK), polyether-imide (PEI), polyethersulfone (PES), polyimide (PI), polyphenylene sulfide (PPS) or polysulfone (PFS), and the blended plastic being ABS/nylon, ABS/PVC, ABS/PC, ABS/SMA (styrene maleic anhydride), PPO (polyphenylene oxide)/PS, PPE (polyphenylene ether)/PS, ABS/polysulfone, PC/PBT, PC/PET, PC/PE, PC/ASA (acrylonitrile-styrene-acrylate), PC/PU, PC/SMA, PBT/ethylene, PET/elastomer, PET/PMMA, PET/polysulfone, PPO/PBT, nylon/ethylene, nylon/elastomer, nylon/PTFE (polytetrafluoroethylene) or PPO/nylon.

11. The forming method of a toilet seat which is integrally formed with an embedded heating wire, according to claim 7, wherein the filler is an organic or inorganic material including wood flours, cellulose pulp, asbestos and mica, having a shape of powder or long fiber.

12. A toilet seat which is integrally formed with an embedded heating wire, being provided between a bowl and a toilet cover, wherein the toilet seat comprises structures constituted by plastic and a heating wire which is embedded by the plastic, and the heating wire contacts with the plastic completely without leaving a gap, thereby forming the toilet seat which is integrally formed with the embedded heating wire.

13. A toilet seat which is integrally formed with an embedded heating wire, being provided between a bowl and a toilet cover, wherein the toilet seat comprises structures constituted by plastic, plate-shaped plastic and a heating wire which is embedded by the plastic and the plate-shaped plastic.

14. The toilet seat which is integrally formed with an embedded heating wire, according to claim 13, wherein the plate-shaped plastic is plate-shaped wood.

15. The toilet seat which is integrally formed with an embedded heating wire, according to claim 12, wherein the heating wire is preferably located at an upper part of the toilet seat and adjacent to a surface of the toilet seat.

16. The toilet seat which is integrally formed with an embedded heating wire, according to claim 6, wherein the thermosetting resin is PE resin, UF resin, epoxy resin, silicone resin, melamine resin, alkyd resin, UP resin or PU resin.
